(19) United States
(12) Patent Application Publication
(10) Pub. No.: US 2017/0320762 A1
(43) Pub. Date: Nov. 9, 2017

(54) OVERCOMING BIOFILM DIFFUSION IN WATER TREATMENT

(71) Applicant: D.C. Water & Sewer Authority, Wahington, DC (US)

(72) Inventors: Sudhir N. Murthy, Herndon, VA (US); Haydee Declippeleir, Washington, DC (US); Eugenio Giraldo, Robbinsville, NJ (US); Ramesh Goel, Salt Lake City, UT (US); Bernhard Wett, Innsbruck (AT)

(21) Appl. No.: 15/588,520

(22) Filed: May 5, 2017

Related U.S. Application Data
(60) Provisional application No. 62/332,965, filed on May 6, 2016.

(51) Int. Cl. C02F 3/10

(52) U.S. Cl. CPC C02F 3/102; C02F 3/103; C02F 3/104

(57) ABSTRACT

Methods and apparatuses for overcoming biofilm diffusion in water treatment by the addition of the substrate flux within biofilm by advection or convection in order to overcome diffusional limitations.

### RELATED APPLICATION

This application claims priority to U.S. provisional application No. 62/332,965 entitled Overcoming Biofilm Diffusion Through Bulk Liquid Advection and Convection in Different Applications, filed on May 6, 2016, the entire disclosure of the provisional application is incorporated herein by reference.

### FIELD OF THE INVENTION

The present invention relates to methods and apparatuses for overcoming biofilm diffusion in water treatment by the addition of the substrate flux within biofilm by advection or convection in order to overcome diffusional limitations.

### BACKGROUND OF THE INVENTION

Biofilms are sessile microbial communities attached to a solid surface and embedded in a matrix of bacterial extracellular polysaccharide substances (EPS). Biofilms are considered very useful in wastewater treatment applications where the usage has ranged from fixed media biofilms to moving bed biofilms. A variety of bacteria spatially distributed within the biofilm degrade different contaminants whose transport into the biofilm is primarily governed by diffusion. See A Multispecies Biofilm Model, by Wanner, O. and Gujer, W., Biotechnology and Bioengineering (1986); Vol. (28): pages: 314-328.

Biofilm reactor performance is evaluated in terms of substrate flux as a function of bulk phase substrate concentration, distribution of microorganism in the biofilm and multi component diffusion. Biofilm growth and contaminant degradation are governed by Fick's second law where biofilm expansion due to contaminant degradation is controlled by substrate diffusion. Equation 1 (below) presents the basic equation used to model substrate diffusion and degradation in biofilms:

$$\frac{δ c}{δ t} = {D}_{f} \frac{{δ}^{2} c}{δ {x}^{2}} - {r}_{F} \qquad ( 1 )$$

Where
c Substrate concentration in the biofilm (M/L³)
x Distance from the biofilm surface (L)
t Time (T)
D_{f} Diffusion coefficient in the biofilm (L²/T)
r_{F} Rate of substrate conversion per biofilm volume (M/L³/T)

Conventional systems and methods associated with biofilm rely on diffusion transport through the biofilm. There is considerable confusion in the literature about the definition of “advection” and “convection” in biofilms. The terms advection and convection are used interchangeably and usually refer to the crossflow transport of flow or solute as a bulk liquid beside the biofilm or tangential to the biofilm. The present invention differentiates between these two terms by defining the term convection to mean the bulk flow of water or gases and the term advection to mean purely used for the flow of the liquid through a biofilm at rates greater than those generated by diffusion forces.

Membrane Biofilm Reactors:

Some of the earliest patents that disclose membrane biofilms are U.S. Pat. Nos. 8,394,273, 7,931,807, and 6,387,262, the subject matter of each of which is herein incorporated by reference, which deals with the diffusive transport of hydrogen gas in a hollow fiber non-porous membrane biofilm reactor where hydrogen is an electron donor to the biofilm for the removal of contaminants. More recently, diffusion of substrates through a membrane biofilm is used to grow specific microorganisms for generating products, such as disclosed in U.S. Published Application No. 2017/0015968, the subject matter of which is herein incorporated by reference.

Other patents or published patent applications disclose membrane aerated biofilm reactors where the gas is oxygen or air, instead of hydrogen, and an electron acceptor is used instead of an electron donor, such as disclosed in U.S. Published Application No. 2016/0002081, the subject matter of which is herein incorporated by reference. For gases used, such as hydrogen, the location within a treatment plant, the structure, the supports or the ancillaries for the membrane biofilm to transport gases ‘from’ the membrane ‘to’ the biofilm are disclosed in U.S. Pat. Nos. 6,908,547, 7,175,763, 7,303,677, 7,699,985, 8,528,745, 8,758,619, 8,986,540, 9,556,046; in PCT International Published Patent Application Nos. WO2016/108227 and WO2016/209234; and Canadian Patent No. CA2458566, the subject matter of each of which is herein incorporated by reference. These patents or patent applications correspond to a family of wastewater treatment approaches that are called membrane biofilm reactors (MBfR) or membrane aerated biofilm reactors (MABR), that are increasingly being considered for various applications in wastewater treatment. In all cases, gases diffuse from the membrane to the liquid. In some of these disclosures, the gas pressure can be managed to modulate its transport across the biofilm that is attached to the membrane. However, these patents and published applications do not disclose, the use of vacuum or negative pressure to pull a gas (instead of pushing gases), the use of combination of positive and negative pressures to pull and push gases, or approaches that specifically focus on enhancing rate limiting solutes or gases.

Gas and Liquid Mass Transfer to or From Membranes:

Many systems exist today for membrane transfer of gases to or from a liquid. PCT International Published Patent Application No. WO2005/016498 describes an apparatus that is used to transfer gas from or to another gas or liquid through a membrane. The membrane apparatus can be a sheet or hollow fiber. However, this apparatus does not have a supporting biofilm for advection. PCT International Published Patent Application No. WO2016/184996, discloses spatial and structural approaches to maximize gas and liquid mass transfer to membrane biofilms and to minimize dead zones, but there is no teaching of creating suitable managed gradients to manage the mass transfer itself. The subject matter of each of WO2005/016498 and WO2016/184996 is herein incorporated by reference.

In an advective flow membrane aerated biofilm reactor, the MABR hollow fibers are stitched together to create a fabric to allow for cross advection of liquid across the fabric and radial flow of gas into a biofilm. The prior art fails, however, to teach the specific transfer of rate limiting solutes or gases within a single system for either liquid transfer or gas transfer, in order to create advective gradients of rate limiting substrates. Picard at al. Discuss in Water Research (2012); Vol. 46, pages: 4761-4769, a change of effective diffusivity in biofilm by convection inside the biofilm; and Casey et al. discuss in Biotechnology and Bioengineering (2000); Vol. 67, Issue 4, pages: 476-486, discusses the impact of liquid flow on biofilm diffusion and boundary layer impacts, but neither teach the use of advection gradients to influence rates for biofilms. Vyrides and Stuckey discuss in Fouling cake layer in a submerged anaerobic membrane bioreactor treating saline wastewaters: curse or a blessing?; Water Science & Technology (2011); Vol. 63, Issue, pages: 2902-2908; DOI: 10.2166/wst.2011.461), the impact of a ‘fouling cake layer’ in a submerged anaerobic membrane bioreactor treating saline wastewaters and determine that the cake layer biofilm outperforms compared to the suspended biology in the reactor. Again, the advection phenomenon on rate limiting solutes is not disclosed as a proposed approach to manage the rates of removal of solutes or gases.

Membrane Biofilm Thickness:

U.S. Pat. No. 9,328,004, the subject matter of which is herein incorporated by reference, discloses an approach to indirectly measure biofilm thickness using pressure. This patent does not, however, use mass transfer to control biofilm thickness. The control of biofilm thickness using advection has not been proposed. The use of approaches to manage biofilm thickness are often limited to shear and self-regulating approaches are not considered.

Compressible Media Filtration:

U.S. Pat. No. 7,572,383, the subject matter of which is herein incorporated by reference, describes the use of compressible media filtration for treatment of wastewater. However, the prior art fails to teach the use of this media to generate advective forces and to improve biological rates from this compression.

### SUMMARY OF THE INVENTION

Accordingly, the present invention relates to the addition of the substrate flux within biofilm by advection or convection in order to overcome diffusional limitations. The result is higher throughput rates and/or lower effluent concentrations of solutes post treatment. The management of fluxes can also control the thickness of the biofilm as higher rates are realized across the biofilm. The biofilm can be supported by any media including membranes, filters, fabrics, compressible media, flow pores, tubes; furthermore the biofilm can be an aggregate of cells in the form of granules formed without a support. The biofilm can also be retained in a reactor with a pressure differential that can move or control solutes, gases or liquids across the biofilm to change the concentration profiles to increase reaction rates.

The thickness of biofilm self-regulates based on the driving force of solutes within the biofilm, that is the biofilm thickness changes depending upon rates of reactions (the kinetics depends on temperature), bulk liquid temperature, viscosity, substrate concentration and other operational conditions. The problem with relying solely on diffusion driving force, is that the first order rates of reaction within a biofilm are much lower at lower solute concentrations. Furthermore, substrate removal in biofilms is mass transport limited. As a result, substrate removal in biofilm reactors is primarily governed by biofilm surface area and substrate flux into the biofilm. In other words, for a given biofilm surface, the more the substrate flux in the biofilm, the better the overall substrate removal will be for a process rate limited by diffusion. The diffusion limitations sometimes become more severe with growing thickness of biofilms resulting in higher residual substrates in the effluent. The present invention can either reduce the diffusional resistance or increase the substrate flux within the biofilm by advection (transport across the biofilm) or convection (bulk flow supported by diffusion such as in channels in granules, tangential flows or crossflows over the biofilm).

For example, oxygen can only penetrate thick biofilms partially and a small fraction of biofilms remain active in supporting aerobic activities. Overcoming oxygen limitations in membrane-attached biofilms-investigation of flux and diffusivity in an anoxic biofilm is disclosed in Water Research; Vol. 38: pages: 1530-1541. The aerobic rates in a biofilms decrease as depths increase. The present invention overcomes diffusion by directly altering the parameters of diffusivity (such as viscosity), or by facilitating transport across a biofilm by managing a pressure gradient. By introducing this pressure gradient across a biofilm, the limitation of relying solely on diffusional driving force is overcome. The authors propose working within the constraints of diffusion by managing the thickness of biofilms, but not specifically to change diffusivity itself or by using other approaches.

Furthermore, the present invention also overcomes the presence of the boundary layer located at the intersection of the bulk liquid and the biofilm. The introduction of active transport across the biofilm increases solute concentrations in the biofilm and results in higher rates of reaction (for first order rates). For diffusion, increased substrate concentrations causes biofilm density to decrease resulting in greater diffusivity. The combined effect of substrate concentration and flow velocity on effective diffusivity in biofilms for diffusion limited biofilms is disclosed in Water Research; Vol. 34, Issue 2, pages: 528-538. A decrease in density can be also be facilitated by the present invention, that is by using active transport, the increased supply of substrate concentration results in thinner biofilms and a lower overcoming differential pressure required. Thus, rates of reaction, final solute effluent concentration, and overcoming differential pressures can be all be optimized and controlled. In addition to pressure gradient, the present invention may also use a draw solution to increase flows of solutes, liquids, gases, substrates, ions, charges or other such material across the biofilm. These draw solutions drive a proton flux, a charge flux of an osmotic flux across the biofilm.

The present invention may provide a method to establish enhanced advective or convective transport through a biofilm of a biologically rate limiting substrate or substrates in the form of a gas, liquid, solute or ion; by creating a substrate draw or feed across this biofilm; using physical, chemical or hydraulic forces; with the purpose of controlling the rate of reaction, or concentration of substrates or solutes within the biofilm, or adjusting the thickness of biofilm.

In some embodiments, the method may include biofilms that are created over membranes, filters, cloths, in self-forming granules or agglomerations or compressible media or a porous support media for facilitating advective flows using a draw or feed solution or using pressure differentials; the limiting reactant in a multiple reactant reaction supplied with the advective or convective flow; the biofilm subject to alternating high and low pressures to induce multidirectional advective or convective flow; advective flow or gradient of solutes, liquids or gases is created by inducing counter-ionic and/or co-ionic flow to facilitate transport of solutes or gases, including proton gradients or other forms of ion-induced gradients using suitable draw or feed solutions, wherein the draw or feed solution can be used in a continuous, intermittent, an alternating manner or with a sensor-based control algorithm; or the proton gradient is developed to increase flux of ammonia, carbon-di-oxide or other solutes or gases that are subject to protonation or deprotonation using acidic or basic draw or feed solutions, wherein the draw or feed solution can be used in a continuous, intermittent, an alternating manner or with a sensor-based control algorithm.

Other embodiments of the method may include advective flow of solutes, liquids or gases promoted through a charge gradient that can be promoted using a cathode or an anode or by using a charged draw or feed solution to direct a counter-charge substrate through the biofilm, wherein the draw or feed solution can be used in a continuous, intermittent, an alternating manner or with a sensor-based control algorithm; advective flow of solutes, liquids or gases promoted through pressure differentials created by capillary forces or surface tension; advective flow of solutes, liquids or gases is promoted through gradients created by Van der Waals forces or by gravitational forces; advective or convective flow promoted through temperature differentials or a thermal gradient across or along the biofilm; advective flow of solutes, liquids or gases promoted through osmotic pressure differentials across the biofilm, wherein a saline or osmosis inducing draw or feed solution can be used in a continuous, intermittent, an alternating manner or with a sensor-based control algorithm; or the rate limitation of the reaction is accumulation of inhibitory products and convective-advective flow is used to evacuate or neutralize such products from or in the biofilm or aggregate, wherein any draw or feed solution employed can be used in a continuous, intermittent, an alternating manner or with a sensor-based control algorithm.

The present invention may yet further provide a method for increasing reaction rates of a rate limiting substrate by increasing diffusivity in biofilm by decreasing fluid viscosity in thixotropic flows in the bulk liquid or within biofilms or flocs by the use of physical, chemical, biological or thermal approaches. In one embodiment, the diffusivity is increased by increasing the temperature and releasing bound water in the biofilm.

The present invention may also provide an apparatus to establish enhanced advective or convective transport of a biologically rate limiting substrate or substrates in the form of a gas, liquid, solute or ion; through a biofilm attached to a porous support or a membrane; by creating a substrate draw or feed across this biofilm; using physical, chemical or hydraulic forces, such as a pressure differential across the biofilm; with the purpose of controlling the rate of reaction, or concentration of substrates or solutes within the biofilm, or adjusting the thickness of biofilm.

In certain embodiments, the biofilm is created on a porous support and the substrate draw is achieved through a pressure differential across the biofilm using a negative, vacuum or positive pressure or an alternating combination thereof; the porous support is a membrane, a filter, a cloth, or a screen that allows for transport of bulk fluid, which could be a gas or liquid or a combination, and minimizes the transport of biofilm material; the biofilm is created on a porous compressible support and advective draw is created by compressing and subsequently expanding the support; hydrocyclones or other vibration or sonication approaches are used to minimize fouling of membranes, filters or other biofilm supports or to improve the draw of substrate through the biofilm; or the biofilm can include tammonia oxidizing organisms, nitrite oxidizing organisms, anaerobic ammonia oxidizing organisms, sulfur oxidizing or reducing organisms, denitrifying methane oxidizing organisms, heterotrophic and methylotrophic denitrifying organisms, methanogenic organisms, heterotrophic organisms, autotrophic organisms, or algae. Any of these organisms can be subject to a substrate, inhibitor or a toxicant to either increase or decrease rates.

The biofilm in its self-agglomerated form or on porous support can be grown in a tank or any vessel for water treatment with influent water (industrial or municipal or any source containing a substrate to be removed), effluent water, and with the possible use of a solid-liquid separation device that could include a membrane, filter, cloth or a clarifier. The biofilm could also be attached to a fully integrated reactor/separator, where in one embodiment the biofilm could be grown on the separator itself (such as a membrane, cloth or filter). The tanks could be operated in a batch, continuous or sequencing batch mode. The tanks could contain activated sludge in an integrated manner. The biofilm could be fixed or moving within these tanks.

The present invention is not limited to the particular methods and systems shown and described herein. Advantages may be achieved by combining and/or operating all or some of the features described herein and shown in FIGS. 1-7.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing figures:

FIG. 1 is a conceptual schematic comparing the convection (bulk transport and diffusion) of biofilm to the convection and advection (bulk transport, diffusion and superimposing advection) and associated pressure differential.

FIGS. 2a-2d are schematics comparing negative and positive VE pressures in gases and water with selected solute's respectively.

FIG. 3 is a representation of biofilm granules changing viscosity and temperature or pore water pressure.

FIG. 4 is a comparison showing flocs increase in diffusivity or advection as a result of changes in bulk water parameters such as viscosity, temperature and pressure.

FIG. 5 is a comparison of activated sludge where channelization due to increased gas transport leading to increased porosity as a result of loading changes.

FIG. 6 is a flowchart showing flow velocity for a rough mushroom shaped biofilm vs a smooth elongated biofilm, displaying the effect of flow velocity leading to the formation of the latter described smooth and more porous biofilm.

FIG. 7 is a flowchart where osmotic pressure assisted diffusion over time in which salt may be added to create osmotic pressure, is known as forward osmosis.

### DETAILED DESCRIPTION OF THE PREFERRED EMBODIMENTS

The present invention relates to the addition of the substrate flux within biofilm by advection or convection in order to overcome diffusional limitations in water treatment. The result is higher throughput rates and/or lower effluent concentrations of solutes post treatment. The management of fluxes can also control the thickness of the biofilm as higher rates are realized across the biofilm. The biofilm can be supported by any media including membranes, filters, fabrics, compressible media, flow pores, tubes; furthermore the biofilm can be an aggregate of cells in the form of granules formed without a support. The biofilm can also be retained in a reactor with a pressure differential that can move or control solutes, gases or liquids across the biofilm to change the concentration profiles to increase reaction rates. In the case of self-forming biofilms, a porous support is not necessarily needed.

The present invention may also include the use of advection gradients to influence rates for biofilms or mass transfer to control biofilm thickness. The control of biofilm thickness using advection which uses this media to generate advective forces and to improve biological rates from this compression. The present invention may also include creating suitable managed gradients to manage the mass transfer of gas and liquid to biofilms to minimize dead zones. Also, the present invention may relate to specific transfer of rate limiting solutes or gases within a single system for either liquid transfer or either gas transfer, in order to create advective gradients of rate limiting substrates. The present invention may also provide the use of vacuum or negative pressure to pull a gas (instead of pushing gases), the use of combination of positive and negative pressures to pull and push gases, or approaches that specifically focus on enhancing rate limiting solutes or gases.

Biofilm thickness self-regulates based on driving force of solutes within the biofilm, in which case the biofilm thickness changes depending upon rates of reactions (the kinetics depends on temperature), bulk liquid temperature, viscosity, substrate concentration and other operational conditions. The problem with relying solely on diffusion driving force, is that the first order rates of reaction within a biofilm are much lower at lower solute concentrations. Furthermore, substrate removal in biofilms is mass transport limited. As a result, substrate removal in biofilm reactors is primarily governed by biofilm surface area and substrate flux into the biofilm. In other words, for a given biofilm surface, the more the substrate flux in the biofilm, the better will be the overall substrate removal for a process rate limited by diffusion. The diffusion limitations often become more severe with growing thickness of biofilms, resulting in higher residual substrates in the effluent. The method in accordance with an exemplary embodiment of the present invention can either reduce the diffusional resistance or increase the substrate flux within the biofilm by advection (transport across the biofilm) or convection (bulk flow supported by diffusion such as in channels in granules, tangential flows or crossflows over the biofilm) to address these problems.

Oxygen, for example, can only penetrate thick biofilms partially and a small fraction of biofilms remain active in supporting aerobic activities. Overcoming oxygen limitations in membrane-attached biofilms-investigation of flux and diffusivity in an anoxic biofilm cause the rates of reaction to increase. The authors propose working within the constraints of diffusion by managing the thickness of biofilms, but not specifically to change diffusivity itself or by using other approaches. The aerobic rates in a biofilms decrease as depths increase. Our approach is to overcome diffusion by directly altering the parameters of diffusivity (such as viscosity), or by facilitating transport across a biofilm by managing a pressure gradient. By introducing this pressure gradient across a biofilm, the limitation of relying solely on diffusional driving force can be overcome. Furthermore, the boundary layer located at the intersection of the bulk liquid and the biofilm can also be overcome. The introduction of active transport across the biofilm will increase solute concentrations in the biofilm and result in higher rates of reaction (for first order rates). For diffusion, increased substrate concentrations causes biofilm density to decrease resulting in greater diffusivity. There is also a combined effect of substrate concentration and flow velocity on effective diffusivity in biofilms for diffusion limited biofilms. A decrease in density can be also be facilitated, by using active transport, the increased supply of substrate concentration will result in thinner biofilms and a lower overcoming differential pressure required. Thus, rates of reaction, final solute effluent concentration, and overcoming differential pressures can be all be optimized and controlled by the method and system of the present invention. Furthermore, the rate of reactions is maximized if the advective forces are applied to rate limiting substrates or gases in a reaction. These rate limitations usually follow first order kinetics. Therefore, a low substrate concentration in the influent or a low desired substrate concentration in the effluent cause these rates to decrease. The present invention manages these rates of reaction by controlling these concentrations through the biofilm and managing the thickness of the biofilm. The thickness of the biofilm is associated with the energy needed, as a pressure differential or other such gradient is maintained across this biofilm, usually requires the use of energy.

The role of convective transport in the bulk liquid and in biofilms is rarely considered. Convective transport through biofilms can be increased by increasing the flow velocity over the biofilm. There is relation between the structure of an aerobic biofilm and the transport phenomena. However, a threshold limit of crossflow (i.e convective bulk flow) was postulated beyond which convective transport had very little effect on mass transport of solute (by diffusion) in biofilm. And there is mass transfer in a membrane aerated biofilm. The methods and systems of the present invention improves mass transport, by applying advection across the biofilm. Thus, a combination of convection (of bulk fluid flows) and advection (flows enhancing diffusional driving force) improves rates of reactions and effluent concentrations. In addition to pressure gradient, a draw solution can be used to increase flows of solutes, liquids, gases, substrates, ions, charges or other such material across the biofilm. These draw solutions can drive a proton (pH related) flux, ionic flux, a charge flux, of an osmotic flux across the biofilm.

The present inventions overcomes biofilm diffusion limitations through in-situ created advective (across the biofilm) and bulk convective gradients or forces. Different strategies may be employed to create advective flows for different types of biofilm applications. For example, advective and convective forces (to overcome diffusion in biofilms) may be generated through, including but not limited to, pressure differentials, facilitated transport, osmotic pressure gradients, viscosity changes (for increasing diffusivity), temperature changes, ionic gradients, and capillary forces. The applications of certain embodiments may include, but are not limited to, biofilms on fixed media (i.e trickling filters, rotating biological contactors, submerged membranes and biofilm membranes) and moving media (i.e biofilms on plastic media, granular sludge reactor, dense flocs). Table 1 summarizes certain types of biofilms, support media and type of force/pressure that may be used to overcome diffusion.

TABLE 1
Classification of different biofilm types and
methods to overcome diffusional limitations.

| Biofilm/process | | |
|---|---|---|
| type | Support media/examples | Advective/convective forces |
| Biofilms on | Liquid transfer | Flow induced advective |
| porous | membranes | forces across attached |
| media | Gas transfer membranes | biofilms |
| Biofilms on | Hollow fiber | Pressure differentials |
| compressible | membranes | (positive or vacuum |
| media | Reverse and forward | pressure) |
| Granular | osmosis membranes | Transmembrane osmotic |
| sludge, | Hydrophobic and | pressure gradients |
| compact | hydrophilic membranes | Transmembrane pressure |
| and dense | Filter surfaces | differential |
| flocs | Screens | Temperature changes |
| Biofilm on | Fabrics | across biofilm or |
| fixed solid | sponge media | membrane |
| media | Granular activated | Advection of solutes |
| Biofilm on | sludge process | during application of |
| moving | Granule or floc filter | compression and |
| media | mats | relaxation |
| | Tricking filter | Convective channelization |
| | Rotating biological | and pressure differentials |
| | contactor | through in-situ biological |
| | Disc filter | gas formation |
| | Moving bed biofilm | Flow induced convective |
| | reactors | forces |
| | Fixed bed filter | Vacuum or positive |
| | | pressure differentials |
| | | Capillary forces |
| | | Van der Waal forces |
| | | pH driven ion transport |
| | | across the biofilm or |
| | | transport |
| | | facilitated ion transport |
| | | counterions for transport |
| | | charge transport using |
| | | draw solutions |
| | | Viscosity changes |

The present invention induces advective forces in a manner roughly perpendicular to the biofilm as well as bulk convective flow roughly parallel to the biofilm by controlling hydrodynamic conditions in the bulk liquid. Certain embodiments of the present invention create convective channels through biofilm (such as for granules) by controlling the substrate loading rates. For example, methane or nitrogen gas bubbles may erupt from granules or fixed film biofilms under increased organic or nitrate/nitrite loading resulting in a net increase in biofilm porosity. In some such embodiments, osmotic pressure differential can be created by changing the ionic strength of the bulk liquid (such as using forward osmosis). A pH or proton gradient can also result in facilitated transport of solutes or gases (example include movement of alkaline gases such as ammonia towards an acidic medium or draw solution, draw solid or draw gas (collectively referred to as draw solution), such as carbon-di-oxide that may be placed on the opposite side of the biofilm or its support). A feed solution, gas or solid (collectively referred to as feed solution) can also be provided. For example, this could be an alkali that can be used to pull an acid and simultaneously provide the required alkalinity for the biofilm. Other forms of ionic gradients are also possible with ionic draw solutions or feed solutions. A charge gradient can also be encouraged by a counter charge draw solution or gas or charge feed solution, solid or gas, or by using a cathode or anode to promote transport of charged solutes or gases across a biofilm. In some cases, it may be desirable to evacuate or add inhibitory substances that can increase or decrease the rates of reaction. Inhibitory or toxic substances can be added to prevent the growth of certain undesirable organisms, while allowing the growth of desirable organisms. In these cases, inhibitory or toxic substances could be added to the feed solution (in the form of a solid, liquid or gas). In other cases, it may be desirable to evacuate inhibitory or toxic substances that are adversely impacting rates of substrate removal or of desirable organisms. In such a situation, a draw solution or a draw approach can be used to evacuate, or a feed approach can be used to neutralize the inhibitory substance.

The present invention also contemplates the use of temperature differentials, which can increase advection or convection in biofilms. For example, warm incinerator scrubber water or heat pumps or other heating or cooling sources/sinks can be used to create temperature differentials across or along biofilms. In other embodiments, capillary action and surface tension effects can also overcome diffusion. In yet other embodiments, processes, such as anaerobic digestion and other thixotropic mediums, the fluid viscosity (such as with thermal hydrolysis) can be decreased to increase resulting rates of reactions. The fluid viscosity can be decreased using physical, chemical, thermal or biological approaches. The reduction in fluid viscosity could occur through the reduction of bound water in the biofilm. In some embodiments, physical, Van der Waals forces, and gravitational forces can be used. In additional embodiments, viscosity of biofilm entrained water may be changed using chemical or physical means. In other such embodiments, bulk temperature can be increased to increase diffusivity where needed.

There are several microorganism groups that are contemplated for the use for biofilms in this invention. Any organism capable of forming a biofilm should be considered a subject of this invention. These include, but are not limited to, ammonia oxidizing organisms, nitrite oxidizing organisms, anaerobic ammonia oxidizing organisms, sulfur oxidizing or reducing organisms, denitrifying methane oxidizing organisms, heterotrophic and methylotrophic denitrifying organisms, methanogenic organisms, heterotrophic organisms, autotrophic organisms, algae. Any of these organisms can be subject to a substrate, inhibitor or a toxicant to either increase or decrease rates.

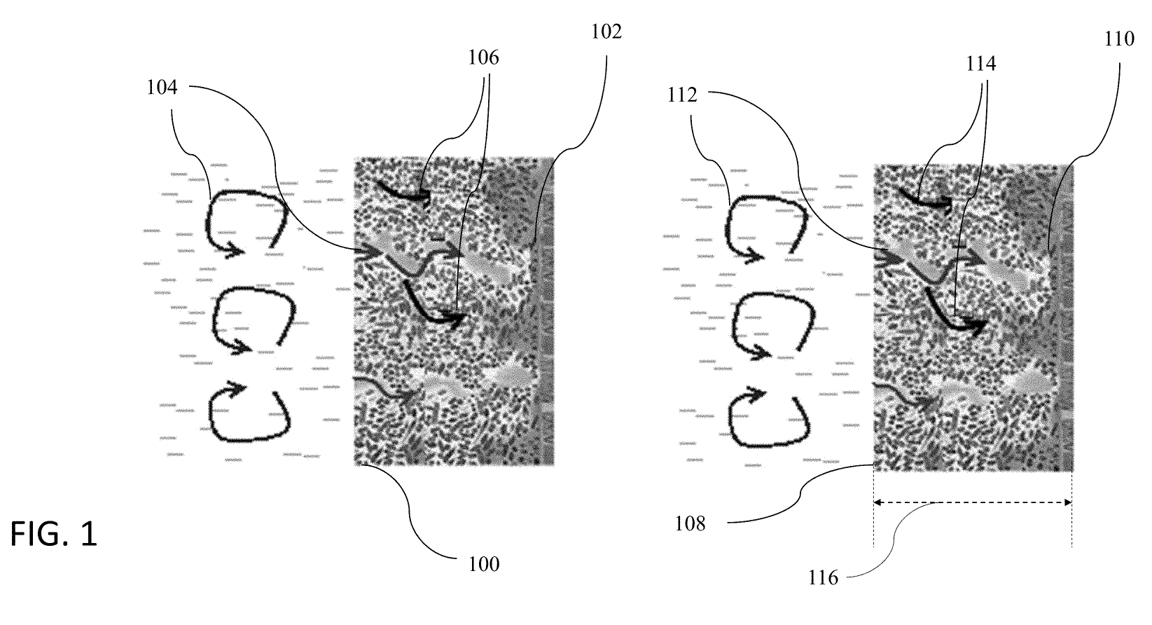

Exemplary embodiments of the present invention are illustrated in FIGS. 1-7.

FIG. 1 is a conceptual schematic displaying the processes of Convection 104, 112 Diffusion 106 and Advection 114 in two otherwise identical biofilms 102 and 110 with the left 100 displaying diffusion and the right 108 displaying advection. The right Biofilm 110 further displays a pressure differential 116 as separated from the left biofilm 102. In this preferred embodiment, convection is defined as the movement of contaminants in the bulk liquid outside of the biofilm due to bulk liquid velocity or in channels within a biofilm (associated with additional diffusion). Diffusion is defined as the transport of containment within dense biofilm due to concentration gradients. Advection is defined as the transport of contaminants within the biofilm under a pressure gradient or through the use of feed or draw solutions.

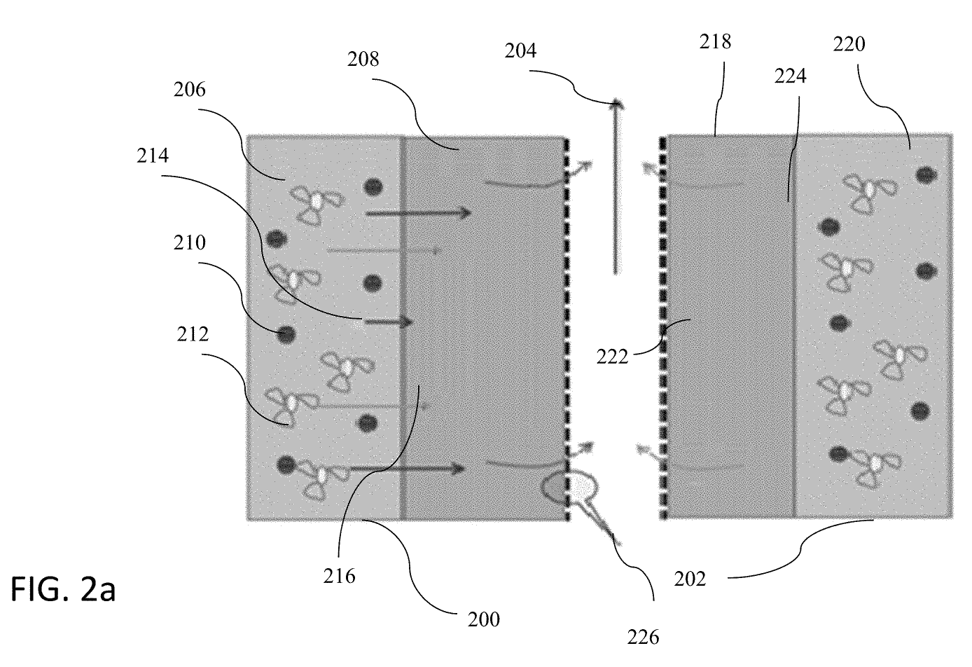

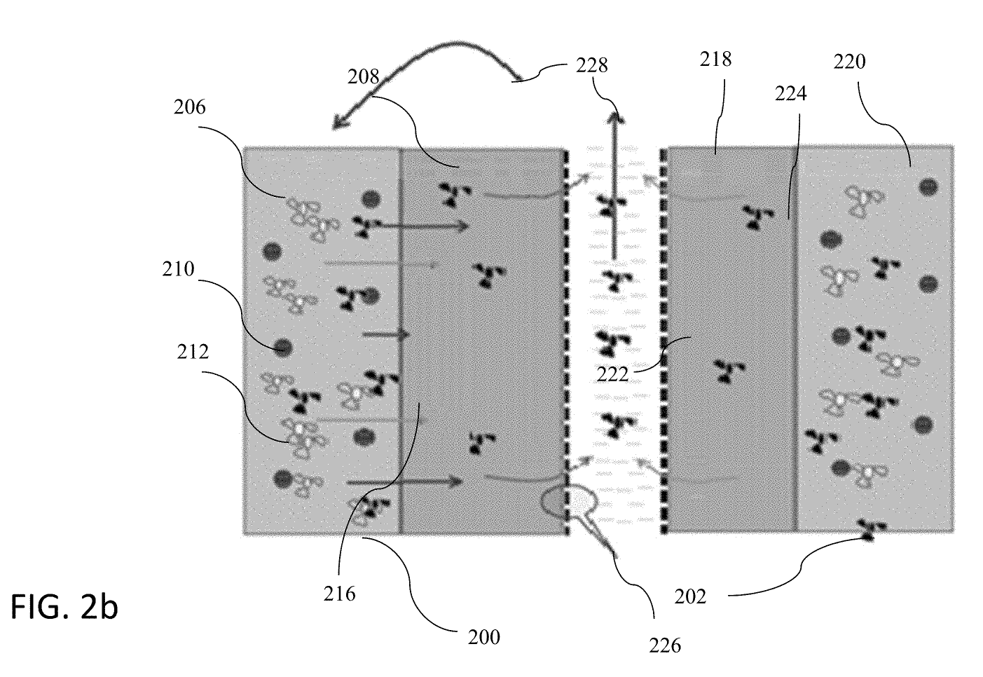

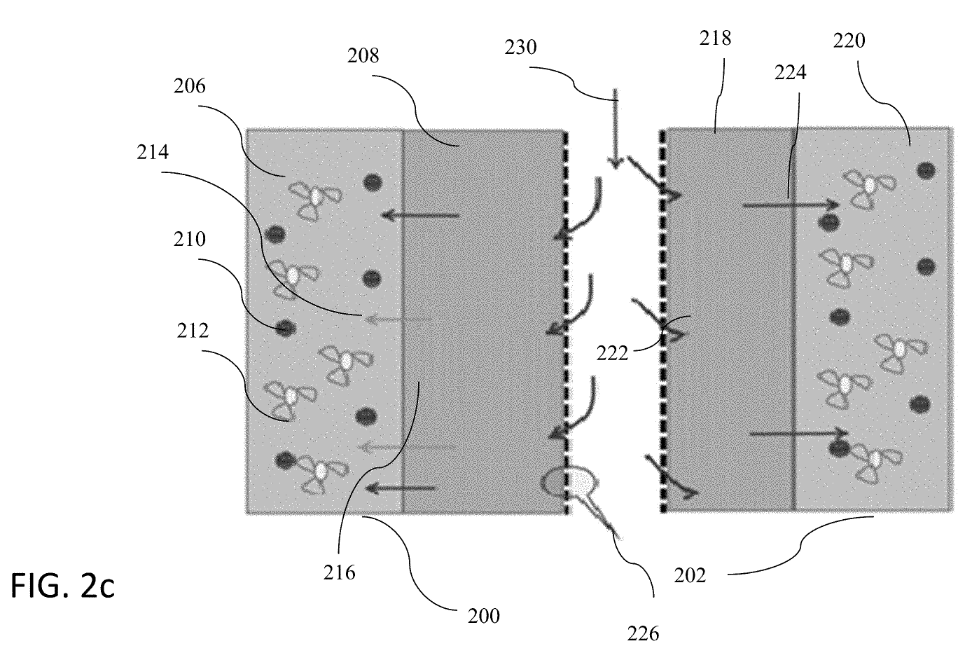

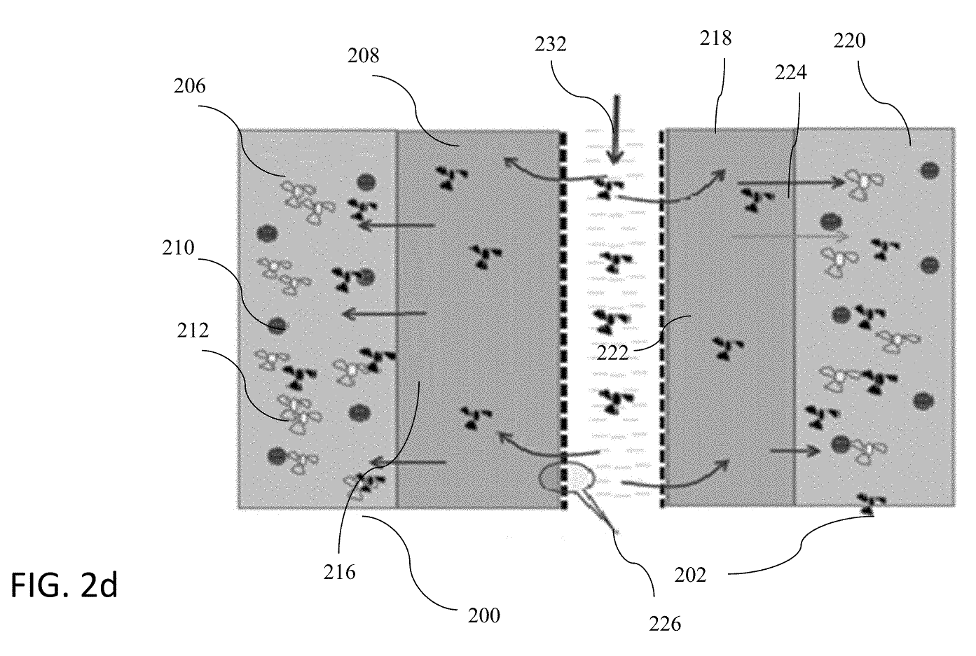

FIGS. 2a-2d are conceptual schematics displaying several preferred embodiments of reverse flow porous media with biofilm (such as a membrane biofilm reactor). In FIG. 2a, this flow displays an embodiment where negative pressure (or using a draw solution) 204 is applied to induce the reverse flow of gases 204 (with hydrophobic surfaces). In FIG. 2b, negative pressure is applied 228 to induce the reverse flow of liquids (with hydrophilic surfaces) with selected solute 228. In FIG. 2c, positive pressure (or the use of feed solutions) is applied to induce the flow of gases (with hydrophobic surfaces). In FIG. 2d, positive pressure is applied to induce the flow of liquids (with hydrophilic surfaces). In each of the preferred embodiments of FIGS. 2a-2d, the left side 200 illustrates Bulk Liquid 206 further comprising mixers 212, supplying solutes such as oxygen 214 to bacteria 210, and partially penetrate a thick biofilm 208 comprising an aerobic bacteria zone 216 and a zone for anoxic/anaerobic bacteria further comprising a membrane attached 226. While the same components are included on the right 202, labels are provided for the Bulk Liquid 220 and Biofilm 218 with the Aerobic Bacteria Zone 224 and Anoxic/Anaerobic Bacteria Zone 222 separately labeled.

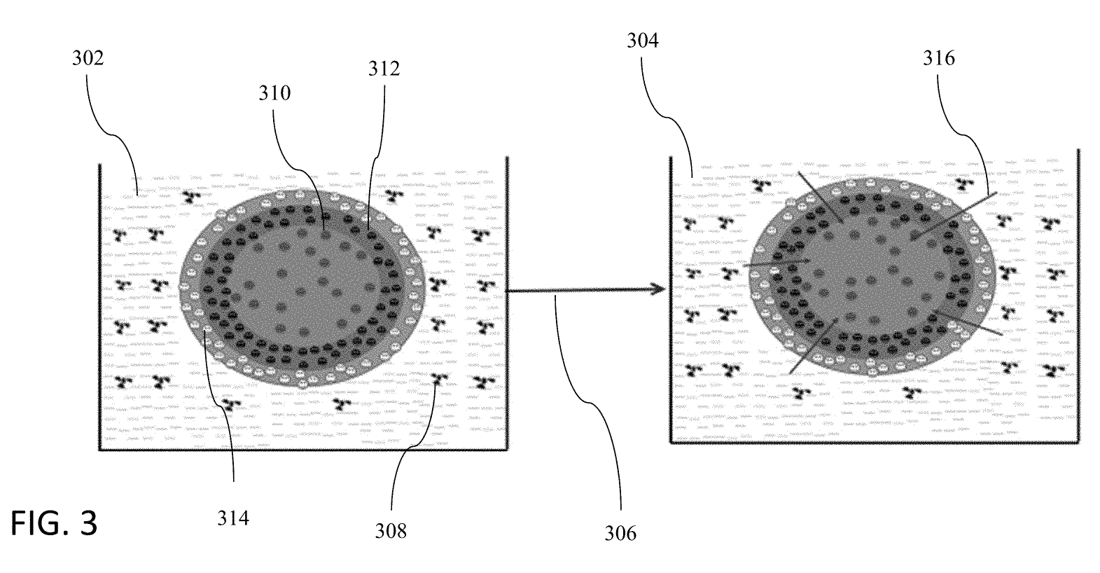

FIG. 3 is a representation of the increase in diffusivity in granules due to an increase in porosity as a result of changes to bulk water parameters such as viscosity, temperature and pressure. The left embodiment 302 displayed in FIG. 3 further comprises a biofilm 314 which has layers 312, 314 which are increasingly penetrated by solutes after apparatus 308 such as pumps or mixers or other thermal or chemical approaches create a change in viscosity, temperature or pore water pressure 306 leading to the right embodiment 304 where diffusivity is increased allowing solutes to increasingly penetrate 316.

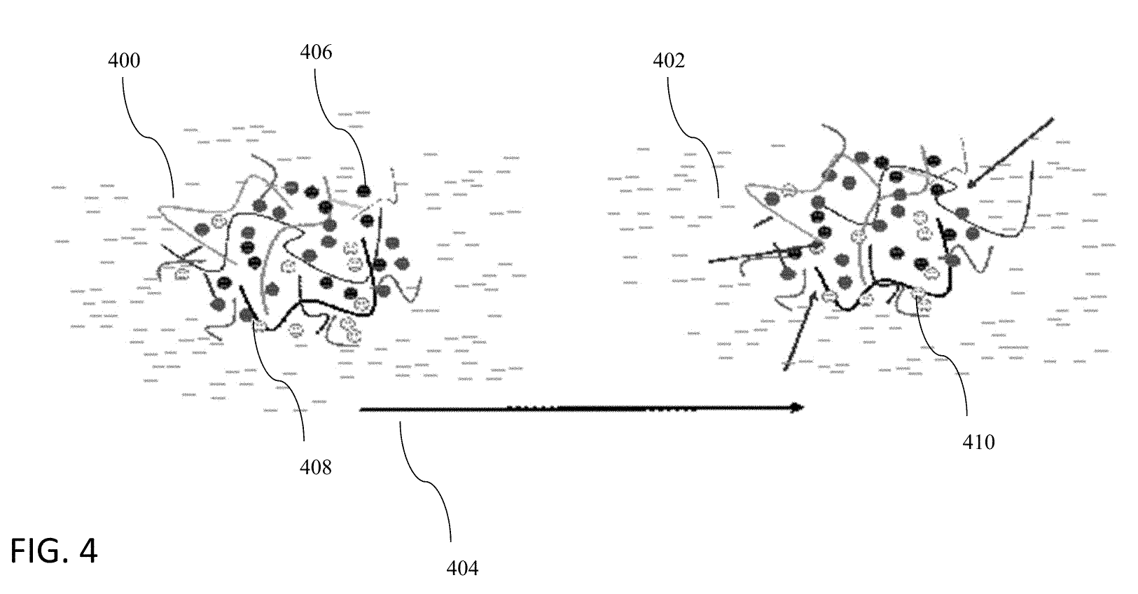

FIG. 4 is a representation displaying an increase in diffusivity in flocs due to an increase in porosity as a result of increased bulk water parameters such as viscosity, temperature and pressure. The left 400 displays flocs 406 in an area of low diffusivity 408 which changes due to change in temperature, loading rate and viscosity 404 such that on the right 402 later in time representation floc activity 410 has increased.

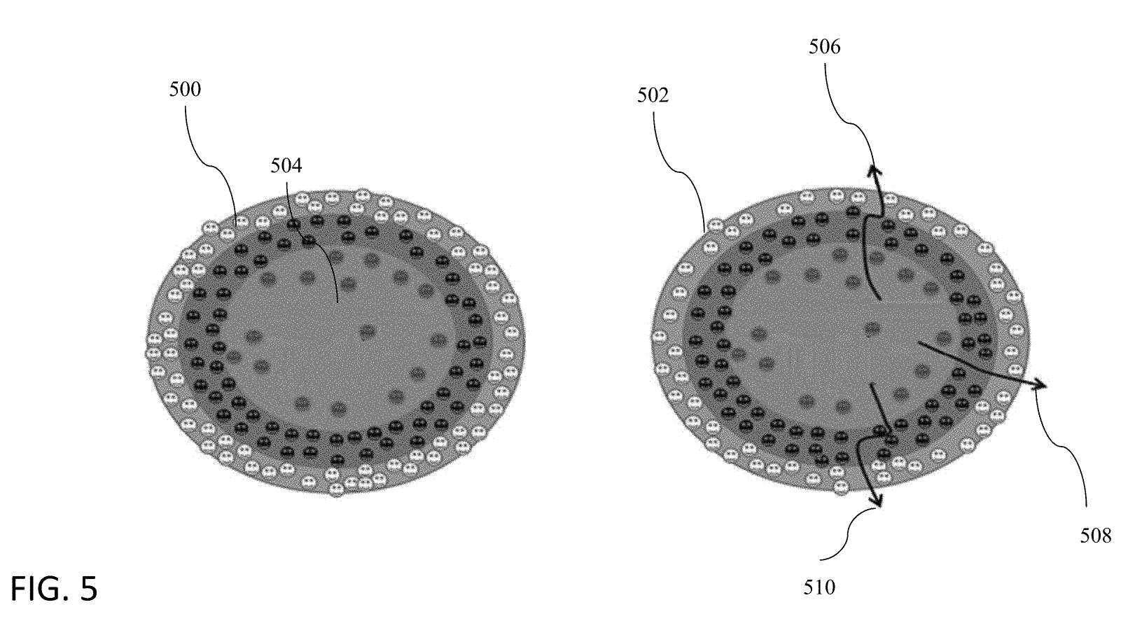

FIG. 5 shows a granular activated sludge reactor where channelization is developed and controlled through gas transport leading to increased porosity as a result of loading changes. In the left FIG. 500 the loading (in Kg m⁻³d⁻¹)=X1 while in the right figure the loading (in Kg m⁻³d⁻¹)=X2 such that X2>X1 allowing for a more convective right environment where CO₂ 506, CH₄ 508, and N₂ 510, freely permeate while a less-porous environment 504 is shown on the left. The porous environment may be seen where CH₄+NO₂->CO₂+N₂, Organics->CH₄ and NO₃->N₂.

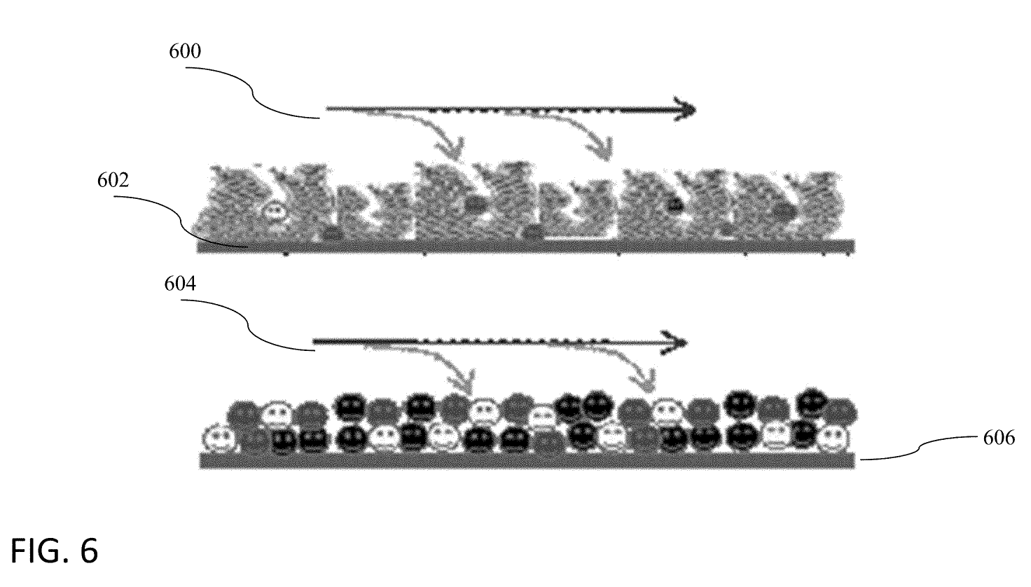

FIG. 6 displays the effect of flow velocity leading to the formation of smooth and more porous biofilm in fixed film biofilms. In an environment where flow velocity is lower 600 a biofilm may be rough and mushroom shaped 602. In a higher flow velocity 604 said biofilm may become smooth and elongated 606.

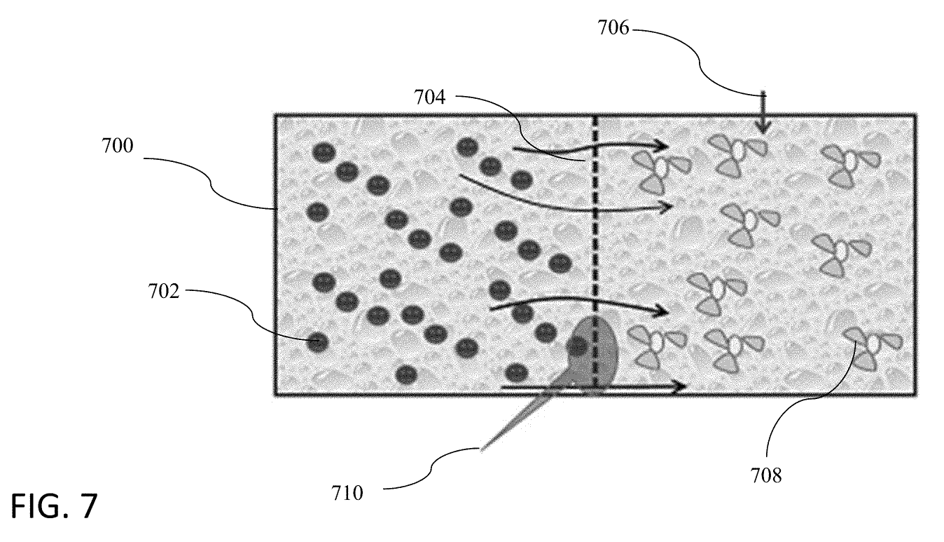

FIG. 7 displays a process of forward osmosis where osmotic pressure 704 assisted diffusion overcomes a 710 semipermeable membrane with a biofilm. The addition of saline draw solution 706 may create osmotic pressure in such an environment 700 allowing solutes 702 to penetrate, as may additional introduction of oxygen with the aid of devices such as mixers 708. In lieu of forward osmosis, ion, charge, proton gradient or other transport approach is also possible with a different draw or feed solution approach.

While particular embodiments have been chosen to illustrate the invention, it will be understood by those skilled in the art that various changes and modifications can be made therein without departing from the scope of the invention as defined in the appended claims.

What is claimed is:

1. A method to establish enhanced advective or convective transport through a biofilm of a biologically rate limiting substrate or substrates, inhibitory products or toxic products in the form of a gas, liquid, solute or ion, comprising the step of
creating a substrate, inhibitor or toxicant draw or feed across this biofilm using physical, chemical or hydraulic forces with the purpose of:
controlling the rate of reaction, or
controlling the concentration of substrates or solutes within the biofilm; or
adjusting the thickness of the biofilm.

2. The method of claim 1, wherein
one or more biofilms are created over membranes, filters, cloths, in self-forming granules or agglomerations or compressible media or a porous support media for facilitating advective flows using a draw or feed solution or using pressure differentials.

3. The method of claim 2, wherein
a limiting reactant in a multiple reactant reaction is supplied with the advective or convective flow.

4. The method of claim 2, wherein
the biofilm is subject to alternating high and low pressures to induce multidirectional advective or convective flow.

5. The method of claim 2, wherein
the advective flow or gradient of solutes, liquids or gases is created by inducing counter-ionic and/or co-ionic flow to facilitate transport of solutes or gases, including proton gradients or other forms of ion-induced gradients using suitable draw or feed solutions wherein the draw or feed solution is used in a continuous, intermittent, an alternating manner or with a sensor-based control algorithm.

6. The method of claim 5, wherein
the proton gradient is developed to increase flux of ammonia, carbon-di-oxide or other solutes or gases that are subject to protonation or deprotonation using acidic or basic draw or feed solutions, wherein the draw or feed solution is used in a continuous, intermittent, an alternating manner or with a sensor-based control algorithm

7. The method of claim 2, wherein
the advective flow of solutes, liquids or gases is promoted through a charge gradient that is promoted using a cathode or an anode or by using a charged draw or feed solution to direct a counter-charge substrate through the biofilm.

8. The method of claim 2, wherein
the advective flow of solutes, liquids, or gases is promoted through pressure differentials created by capillary forces or surface tension.

9. The method of claim 2, wherein
the advective flow of solutes, liquids, or gases is promoted through gradients created by Van der Waals forces or by gravitational forces.

10. The method of claim 2, wherein
the advective or convective flow is promoted through temperature differentials or a thermal gradient across or along the biofilm.

11. The method of claim 2, wherein
the advective flow of solutes, liquids or gases is promoted through osmotic pressure differentials across the biofilm, wherein a saline or osmosis inducing draw or feed solution is used in a continuous, intermittent, an alternating manner or with a sensor-based control algorithm.

12. The method of claim 2, wherein
the rate limitation of the reaction is accumulation of inhibitory products and convective-advective flow is used to evacuate or neutralize such products from or in the biofilm or aggregate wherein the draw or feed is used in a continuous, intermittent, an alternating manner or with a sensor-based control algorithm.

13. A method for increasing reaction rates of a rate limiting substrate, comprising the step of:
increasing diffusivity in biofilm by decreasing fluid viscosity in thixotropic flows in the bulk liquid or within biofilms or flocs by the use of a physical, a chemical, a biological, or a thermal process.

14. The method of claim 13, wherein
hydrocyclones, vibration, or sonication improves biofilm diffusivity.

15. The method of claim 13, further comprising the step of:
increasing diffusivity by increasing the temperature and releasing bound water in the biofilm.

16. An apparatus to establish enhanced advective or convective transport of a biologically rate limiting substrate or substrates in the form of a gas, liquid, solute or ion, comprising:
a biofilm attached to a porous support or a membrane that is contained in a vessel or a tank with a influent and effluent stream with a separate or an integrated solid liquid separator; and
a substrate draw or feed across the biofilm created by physical, chemical or hydraulic forces to control the rate of reaction, concentration of substrates or solutes within the biofilm, or adjust the thickness of the biofilm.

17. The apparatus of claim 16, wherein
the biofilm is created on a porous support and the substrate draw is achieved through a pressure differential across the biofilm using a negative vacuum or positive pressure or an alternating combination thereof.

18. The apparatus of claim 17, wherein
the porous support is a membrane, a filter, a cloth, or a screen that allows for transport of bulk fluid that is a gas or liquid or a combination thereof, and minimizes the transport of biofilm material.

19. The apparatus of claim 16, wherein
the biofilm is created on a porous compressible support and advective draw is created by compressing and subsequently expanding the support.

20. The apparatus of claim 16, wherein
hydrocyclones, vibration, or sonication minimize fouling of membranes, filters or other biofilm supports, to improve the draw of substrate through the biofilm.

21. The apparatus of claim 16, wherein
the biofilm includes tammonia oxidizing organisms, nitrite oxidizing organisms, anaerobic ammonia oxidizing organisms, sulfur oxidizing or reducing organisms, denitrifying methane oxidizing organisms, heterotrophic and methylotrophic denitrifying organisms, methanogenic organisms, heterotrophic organisms, autotrophic organisms, or algae.

22. The apparatus of claim 16, wherein
hydrocyclones, vibration, or sonication minimize fouling of membranes, filters or other biofilm supports, or improve biofilm porosity, to improve the draw of substrate through the biofilm.
